(19) United States
(12) Patent Application Publication
(10) Pub. No.: US 2007/0178929 A1
(43) Pub. Date: Aug. 2, 2007

(54) Mobile communication terminal and method capable of quickly connecting with base station using efficient transmission power control

(76) Inventor: Oui Sung Kim, Seoul (KR)

Correspondence Address: FENWICK & WEST LLP, SILICON VALLEY CENTER, 801 CALIFORNIA STREET, MOUNTAIN VIEW, CA, 94041, US

(21) Appl. No.: 11/497,575

(22) Filed: Aug. 1, 2006

(30) Foreign Application Priority Data
Jan. 19, 2006 (KR) 10-2006-0005812

(51) Int. Cl. H04B 7/00; H04Q 7/20

(52) U.S. Cl. 455/522

(57) ABSTRACT

A mobile communication terminal and a method which is capable of quickly connecting with base station by efficiently controlling a transmission power are provided. The mobile communication terminal reads a recent power value of a transmitter which successfully connected to a base station from a nonvolatile memory, and tries to connect to the base station. When the connection is successful, the mobile communication terminal decreases the power value of a transmitter by a predetermined amount until the connection fails, and may store again the power value of the transmitter which successfully connected to the base station right before the connection to the base station fails, as the recent power value in the nonvolatile memory, according to the decreasing the power value of the transmitter.

### CROSS-REFERENCE TO RELATED APPLICATION

This application claims the benefit of Korean Patent Application No. 10-2006-0005812, filed on Jan. 19, 2006, in the Korean Intellectual Property Office, the disclosure of which is incorporated herein by reference.

### BACKGROUND OF THE INVENTION

1. Field of the Invention

The present invention relates to a transmission power (Tx power) control method of a mobile communication terminal, and more particularly, to a method of increasing or decreasing a Tx power of a transmitter in order to connect to a base station based on a recent power value so that the mobile communication terminal efficiently connects to the base station quickly.

2. Description of Related Art

In modern society, many people use a mobile communication terminal for a long distance communication. The mobile communication terminal is widely used as a necessity since the mobile communication terminal provides a function that a user may conveniently communicate while moving and regardless of a location. As recent developments in mobile communication terminal technologies have improved and memory resources have been increased, the mobile communication terminal has provided various functions for various fields as well as a conventional mobile communication service.

A conventional mobile communication terminal uses a method of simply increasing a Tx power as a method in order to try to connect to a base station.

FIG. 1 is illustrating a conventional method that a mobile communication terminal connects to a base station.

As illustrated in FIG. 1, in operation 10, a mobile communication terminal tries to connect with an initial power value which is stored in a memory according to an access probe in order to connect to a base station. When the connection to the base station is failed with the initial power value, the mobile communication terminal repeatedly tries to connect to the base station by increasing a power value, i.e. mobile Tx power by a predetermined amount. Accordingly, in operation 120, a mobile Tx power value of the mobile communication terminal that enables communication with the base station is ascertained. Also, the connection to the base station is maintained.

In this method, the mobile communication terminal ascertains an mobile Tx power value by gradually increasing the power value from the initial power value which is set low. Accordingly, connecting to the base station takes a relatively long time and a high power consumption.

### SUMMARY OF THE INVENTION

The present invention provides a transmission power control method of a mobile communication terminal which attempts to connect to a base station by using a transmission power value, that was used in a most recently successful connection to the base station, stored in a nonvolatile memory, and searches for an optimum transmission power by increasing and decreasing a transmission power of a transmitter by a predetermined amount according to a success or a failure of a connection.

The present invention also provides a mobile communication terminal attempting a connection based on a recent power value that successfully connected to the base station, and efficiently controls the power value to effectuate a fast connection.

According to an aspect of the present invention, there is provided a transmission power control method of a mobile communication terminal, the method including: reading a recent power value of a transmitter which successfully connected to a base station, from a nonvolatile memory; decreasing a power value of the transmitter by a predetermined amount to be less than the recent power value until a connection to the base station fails, when the connection to the base station was successful with the recent power value; and storing the power value of the transmitter which successfully connected to the base station immediately prior to the power value with which the connection to the base station fails, as the recent power value in the nonvolatile memory, according to the decreasing a power value of the transmitter.

The transmission power control method of a mobile communication terminal, the method further including: increasing the power value of the transmitter by the predetermined amount to be greater than the recent power value until the connection to the base station succeeds, when the connection to the base station had failed with the recent power value; and storing the power value of the transmitter which successfully connected to the base station as the recent power value in the nonvolatile memory, according to the increasing a power value of the transmitter.

According to another aspect of the present invention, there is provided a mobile communication terminal, the terminal including: a nonvolatile memory storing a recent power value of a transmitter which successfully connected to a base station; and a control unit controlling the transmitter to transmit a signal to the base station according to the recent power value stored in the nonvolatile memory for a connection to the base station, and determining a success of the connection when a corresponding response is received from the base station, or determining a failure of the connection when the corresponding response is not received from the base station, wherein the control unit decreases the power value of the transmitter by a predetermined amount to be less than the recent power value until the connection to the base station fails and stores the power value of the transmitter which successfully connected to the base station immediately prior to the power value with which the connection to the base station fails, as the recent power value in the nonvolatile memory, when the connection to the base station was successful with the recent power value.

The control unit increases the power value of the transmitter by the predetermined amount to be greater than the recent power value until the connection to the base station succeeds, and stores the power value of the transmitter which successfully connects to the base station as the recent power value in the nonvolatile memory, when the connection to the base station fails by the recent power value.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is illustrating a conventional method that a mobile communication terminal connects to a base station;

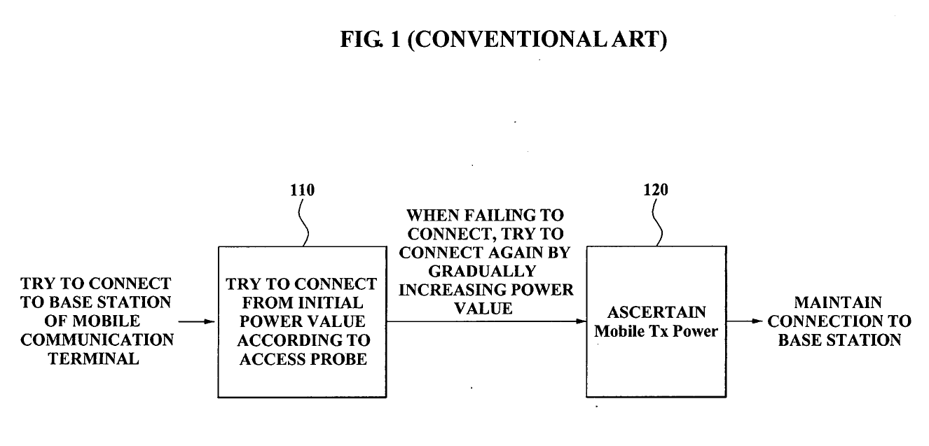

FIG. 2 is illustrating a transmission power control method of a mobile communication terminal according to an embodiment of the present invention;

FIG. 3 is illustrating an algorithm of setting a mobile transmission power value of a mobile communication terminal according to an embodiment of the present invention;

FIG. 4 is illustrating a transmission power control system according to an embodiment of the present invention; and

FIG. 5 is illustrating an internal configuration of a mobile communication terminal illustrated in FIG. 4.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

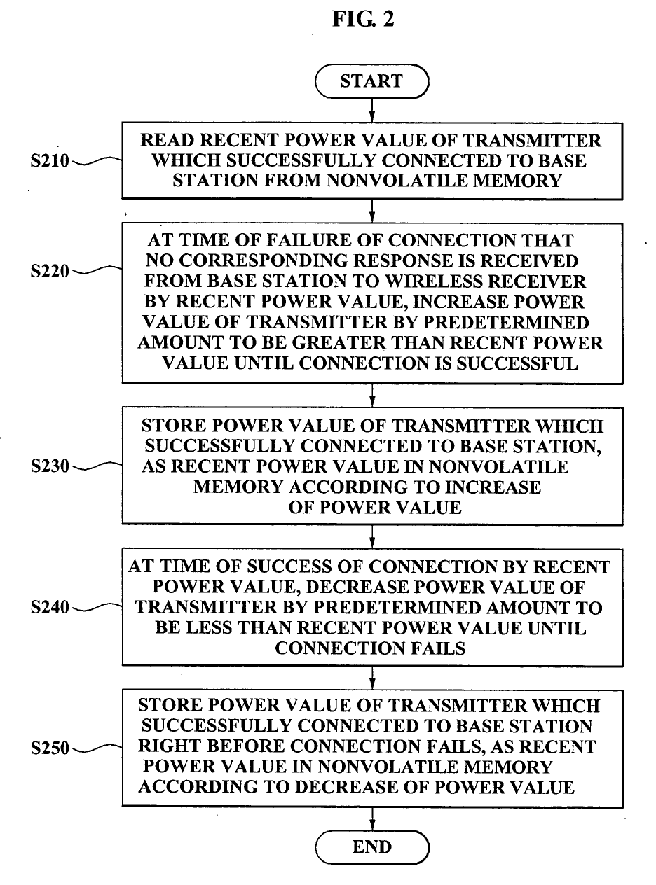

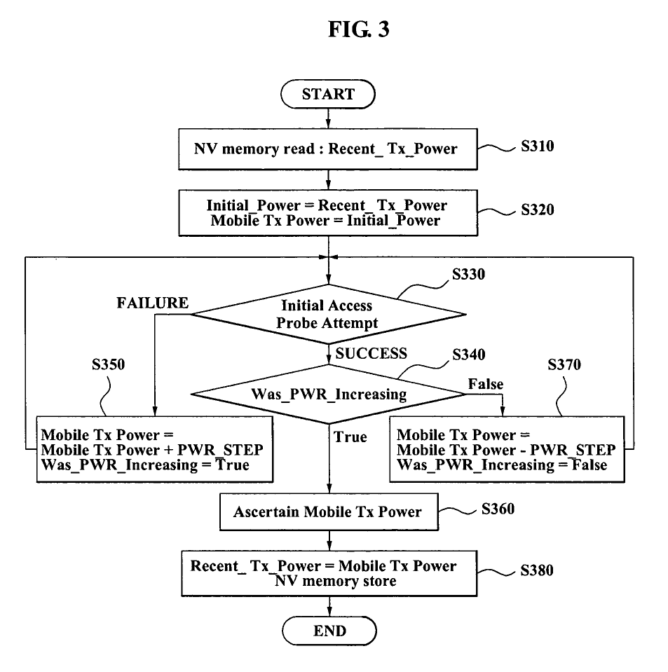

FIG. 2 is illustrating a transmission power (Tx power) control method of a mobile communication terminal according to an embodiment of the present invention. FIG. 3 is illustrating an algorithm of setting a mobile Tx power value of a mobile communication terminal according to an embodiment of the present invention.

In operation S210, a recent power value which successfully connected to a base station is read from a nonvolatile memory. For this operation, in operation S310, a nonvolatile memory (NV) installed in the mobile communication terminal stores a recent Tx power value Recent_Tx_Power which was used to connect to the base station most recently. Accordingly, in operation S320, when the mobile communication terminal attempts to make a new connection to the base station, the new connection attempt may be made with the recent Tx power value Recent_Tx_Power as an initial power value of a transmitter.

In operation S220, when a connection is failed, i.e. there is no corresponding response from the base station to a wireless receiver with the recent Tx power value Recent_Tx_Power, the power value of the transmitter is repeatedly increased by a predetermined amount to be greater than the recent power value until the connection is successful. Namely, for this operation, in operation S350, when the mobile communication terminal fails to connect to the base station, the mobile communication terminal increases the power value of the transmitter by a predetermined numerical value PWR_STEP. The mobile communication terminal repeats operation S330, again attempting an access probe to the base station with the increased Tx power value. Attempts to connect to the base station may be repeatedly performed. In operation S340, as a result of the attempts, when the connection to the base station is successful, the mobile communication terminal checks whether the mobile Tx power value was increased or not, i.e. whether Was_PWR_Increasing is True or False. In this instance, the Was_PWR_Increasing is a flag indicating whether the mobile Tx power value was increased or not. In operation S230, when the connection is successful from an increase in the power value, the power value of the transmitter which successfully connected to the base station is stored as the recent power value Recent_Tx_Power in the nonvolatile memory.

In operation S340, when the mobile communication terminal successfully connects to the base station during an initial access probe attempt, the mobile communication terminal checks whether the recent Tx power should be increased by adding the predetermined PWR_STEP. In operation S360, as a result of the checking Was_PWR_Increasing, when the recent Tx power value Recent_Tx_Power is increased, the mobile communication terminal ascertains a mobile Tx power value. However, as a result of the checking when the recent Tx power value Recent_Tx_Power is not increased, the mobile communication terminal repeats operation S330 in order to attempt the access probe again by subtracting a predetermined amount PWR_STEP from the recent Tx power value Recent_Tx_Power for adjusting the mobile Tx power value.

Namely, in operation S240, when the connection to the base station is successful with the recent power value, the mobile communication terminal decreases the recent Tx power value Recent_Tx_Power of the transmitter by a predetermined amount PWR_STEP to be less than the recent power value until the connection to the base station fails. In this instance, in an operation of decreasing the recent Tx power value Recent_Tx_Power of the transmitter by the predetermined amount PWR_STEP to be less than the recent power value Recent_Tx_Power, when the connection continues to be successful even after a predetermined period passes, the power value may be decreased by a greater amount. Accordingly, the time to ascertain the most suitable mobile power value may be largely reduced.

The access probe is repeatedly attempted until the access probe attempt fails. Also, the mobile communication terminal may determine whether the mobile Tx power value needs to be increased again. Accordingly, when the mobile communication terminal repeatedly increases the mobile Tx power value until the access probe attempt fails, the mobile communication terminal may store the power value of the transmitter which successfully connected to the base station immediately prior to the power value with which the connection to the base station fails, as the recent power value Recent_Tx_Power in the nonvolatile memory. Namely, in operation S250, according to the decreasing the power value of the transmitter, the mobile communication terminal stores the power value of the transmitter which successfully connected to the base station immediately prior to the power value with which the connection to the base station fails, as the recent power value in the nonvolatile memory. For this operation, in operation 380, the recent power value Recent_Tx_Power becomes the mobile Tx power value. Also, the mobile Tx power value is stored as a power value which will be used in a next connection attempt in the nonvolatile memory.

Finally, when the mobile Tx power value which recently succeeded in an access probe is stored in the nonvolatile memory of the mobile communication terminal, the mobile communication terminal reads the power value stored in the nonvolatile memory when the a new access probe is attempted, and sets the power value as the initial power value. The mobile communication terminal may then search for a suitable Tx power value by increasing and decreasing the power value by the PWR_STEP based on the initial power value. Also, the suitable Tx power value is stored in the nonvolatile memory and may be used when a subsequent access probe is attempted. When the mobile communication terminal connects to the base station for a voice service or data service by using the nonvolatile memory, the Tx power of the transmitter may be efficiently controlled.

The Tx power control method of a mobile communication terminal according to the above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

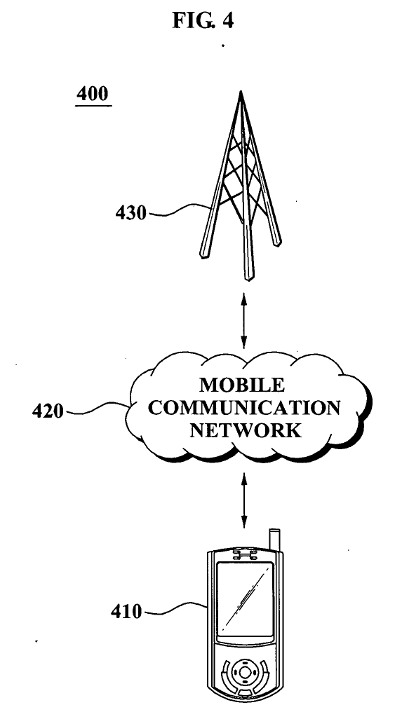

FIG. 4 is illustrating a Tx power control system 400 according to an embodiment of the present invention.

As shown in FIG. 4, the Tx power control system 400 includes a mobile communication terminal 410, a mobile communication network 420, and a base station 430.

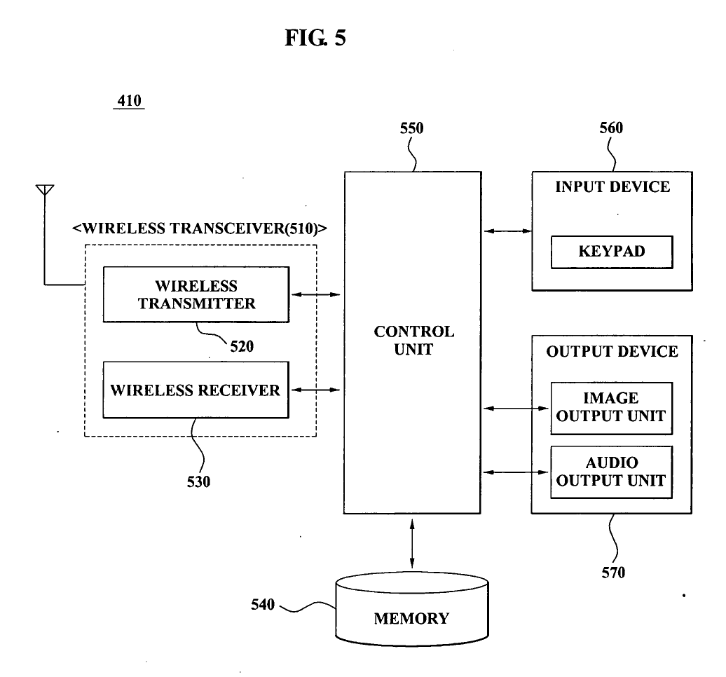

The mobile communication terminal 410 stores, a most recently used mobile Tx power value which succeeded in an access probe, in a nonvolatile memory. When the mobile communication terminal 410 attempts the access probe, an initial power value is set by using the mobile Tx power value stored in the nonvolatile memory. Also, the mobile communication terminal may search for a suitable Tx power value by increasing and decreasing by a predetermined power value with the initial power value as a starting point. The suitable Tx power value is then stored in the nonvolatile memory, and may be used when a subsequent access probe is attempted. A more detailed description of an operation of the mobile communication terminal 410 will be described with reference to FIG. 5.

The mobile communication terminal 410 as used in the present specification includes mobile communication devices, such as a Personal Digital Cellular (PDC) phone, a personal communication service (PCS) phone, a personal handyphone system (PHS) phone, a Code Division Multiple Access (CDMA)-2000 (1×, 3×) phone, a Wideband CDMA phone, a dual band/dual mode phone, a Global System for Mobile Communications (GSM) phone, a mobile broadband system (MBS) phone, a Digital Multimedia Broadcasting (DMB) phone, and a cellular phone; portable terminals such as a personal digital assistant (PDA), a hand-held PC, a notebook PC, a wireless broadband Internet (WiBro) terminal, a smart phone, and an MP3 player; and all types of hand-held based wireless communication devices including an International Mobile Telecommunication (IMT)-2000 system providing international roaming service and extended mobile communication service.

Also, the mobile communication terminal 410 may include a predetermined communication module such as a CDMA module, a Bluetooth module, an Infrared Data Association (IrDA) module, a wired/wireless LAN card and a wireless communication device which is provided with a global positioning system (GPS) chip enabling tracking of a position via a GPS. Also, the mobile communication terminal 410 may include a microprocessor which can play multimedia and perform a certain calculation operation.

The mobile communication network 420 refers to a network connecting a mobile communication terminal and a fixed point, or between mobile communication terminals. The mobile communication network 420 may be applicable to various mobile communication systems including a cellular mobile communication system. Also, a base station which relays a radio wave of the mobile communication terminal 410 as a wireless station communicating with a portable electric and electronic device may be used together. Also, a gateway which is used as a unit or an apparatus enabling exchanging information between networks by connecting to a plurality of different kinds or a same kind of network to each other may be used together.

The base station 430 relays the transceiving radio wave of the mobile communication terminal 410 as a wireless station communicating with a portable electric and electronic device. Also, the base station 430 is constructed on the ground and does not move for a communication with a land mobile station or a communication by relaying a signal of a mobile relay station. The base station 430 may include a base station system constructing the base station in a mobile communication. The base station system is divided into a base station controller (BSC) and a base transceiver station (BTS). The BSC manages a connection to various kinds of cable networks and a BTS control, and the BTS manages a wireless transmission with the mobile communication terminal 410. Also, the base station 430 according to the present invention refers to a base station corresponding to a radius of a cell including the mobile communication terminal 410 as well as a plurality of base stations related to the mobile communication terminal 410.

FIG. 5 is illustrating an internal configuration of the mobile communication terminal 410 illustrated in FIG. 4.

As shown in FIG. 5, the mobile communication terminal 410 includes a wireless transceiver 510 including a wireless transmitter 520 and a wireless receiver 530, a memory 540, a control unit 550, an input device 560, and an output device 570.

The wireless transceiver 510 is a wireless transmitting and receiving unit which is used to execute a mobile communication service while transmitting/receiving a radio wave to/from a base station and transmits or receives predetermined information according to the present invention. Also, the wireless transceiver 510 may combine the wireless transmitter 520 and the wireless receiver 530 in a single package, and may generally include an antenna. Also, the wireless transceiver 510 may be used in all wireless transmission devices such as a cellular phone, a wireless telephone, and a handie talkie. The wireless transceiver 510 may transmit or receive an analog signal or a digital signal. The wireless transmitter 520 transmits a signal for connecting to the base station. The wireless receiver 530 receives a signal from the base station responding to a transmission signal from the wireless transmitter 520.

Also, when the wireless transmitter 520 and the wireless receiver 530 are connected to a same antenna, a predetermined electronic switch may be used in the wireless transceiver 510 to prevent an output of the wireless transmitter 520 from interfering with the wireless receiver 530. Accordingly, when the wireless transceiver 510 is embodied in this method, a half-duplex wireless transceiver, in which receiving a signal during a process of transmitting the signal is not possible, may be used. Also, transmitting and receiving the signal may be processed within a same frequency band. An above-described method is generally used in a handie talkie.

Also, a full-duplex wireless transceiver enabling receiving a signal while transmitting a signal may be designed. In this instance, signals of the wireless transmitter 520 and the wireless receiver 530 may not affected each other since sufficiently separated frequencies are used to prevent interference. An above-described method is generally used in a cellular phone, a wireless mobile phone, etc. As another wireless transceiving method, a satellite communication network of subscriber lines also applies to the full-duplex wireless transceiver. The full-duplex wireless transceiver utilizes an uplink signal transmitted to a satellite and a downlink signal received from the satellite.

The memory 540 stores a recent power value of the wireless transmitter 520 which successfully connected to the base station 430 like the above for a voice or data service. Also, the memory 540 may be used as a temporary memory storing the recent power value of the wireless transmitter 520 which successfully connected to the base station. Also, the memory 540 may be used in order to retrieve the recent power value which successfully and most recently connected to the base station 430 so as to attempt to make a new connection to the base station 430. Also, a nonvolatile memory such as a nonvolatile dynamic random access memory (nonvolatile DRAM) which embodies a fast write capability of DRAM and a nonvolatile function of a flash memory, or a NAND memory may be used as the memory 540.

The control unit 550 manages an overall control of each component of the mobile communication terminal 410. Also, especially in the present invention, the wireless transmitter 520 transmits the signal based on the recent power value which is stored in the nonvolatile memory 540 for connecting to the base station. When attempting connect to the base station 430, the control unit 540 controls connection to the base station 430 according to the recent power value and determines a success or a failure of the connection, i.e. determines whether a corresponding response is received from the base station 430 to the wireless receiver 530 or not. Also, the control unit 550 increases the power value of the wireless transmitter 520 by the predetermined amount to be greater than the recent power value until the connection to the base station is successful, and stores the power value of the wireless transmitter 520 which successfully connected to the base station, as the recent power value in the nonvolatile memory 540, when the connection to the base station fails by the recent power value. Also, the control unit 550 decreases the power value of the wireless transmitter 520 by a predetermined amount to be less than the recent power value until the connection to the base station fails and stores the power value of the wireless transmitter 520 which successfully connected to the base station right before the connection to the base station fails, as the recent power value in the nonvolatile memory 540, when the connection to the base station is successful by the recent power value.

Namely, the control unit 550 receives an acknowledgement message from the base station 430 according to an initial access probe attempt in the mobile communication terminal 410. In this instance, when a connection to the base station 430 is successful, the control unit 550 may search for a more suitable power value by decreasing the power value of the wireless transmitter 520 by a small amount and store the power value of the wireless transmitter 520 in the memory 540. In this instance, the control unit 550 controls the power value of the wireless transmitter 520 to be decreased by the predetermined amount to be less than the recent power value for a predetermined period until the connection to the base station fails, and controls the power value to be decreased by a greater amount than the predetermined amount after the predetermined period passes. For example, the control unit 550 increases a numerical value in order to decrease the power value by a predetermined multiple such as two times or two and a half times or controls the numerical value to increase by using other various methods. Also, when not receiving the acknowledgement message and failing to connect to the base station 430, the control unit 550 increases the predetermined power value and searches for a mobile Tx power. In this instance, the control unit 550 may control the power value to be repeatedly increased until the connection is successful.

Also, the control unit 550 generally may be a processor processing all data of the communication terminal 410 using a digital signal processor (DSP). As more DSP is constructed to process internal signals such as a baseband signal, an operation according to each mode may be more quickly processed due to a fast processing speed. A mobile station modem (MSM), an open multimedia application platform (OMAP), etc., may be used as the control unit 550.

The input device 560 is an apparatus to input commands or set the mobile communication terminal 410. A keypad, a touch screen, a touch pad, and a speech recognition module may be used as the input device 560.

The output device 570 may be an apparatus to verify a set condition and communication information of the mobile communication terminal 410. The output device 570 may include a visual output device, such as a liquid crystal display (LCD), an organic light-emitting diode (OLED), an LED, and a plasma display panel (PDP), etc. Also, the output device 570 may include an audible output device including an earphone and a speaker outputting various sounds such as a bell sound, a coloring service, and a MP3 player, etc. The output device 570 may include a haptic device utilizing a vibrating motor, etc.

Embodiments described herein in association with a mobile communication terminal 410 may be applicable to a base station 430. Also, the contrary thereto is possible.

A mobile communication terminal controlling a Tx power according to the present invention has been described hereto, and the above-mentioned description in the embodiments of FIGS. 2 through 4 may be applied to the embodiment of FIG. 5. Accordingly, a detailed description thereto will be omitted.

According to the present invention, a mobile communication terminal attempts to connect to a base station by using a recent power value, that was used in a most recently successful connection to the base station, stored in a nonvolatile memory. The mobile communication terminal increases or decreases a predetermined Tx power value according to a success or a failure of a connection. Accordingly, the mobile communication terminal may search for an optimum mobile Tx power. Accordingly, the mobile communication terminal may quickly connect to the base station, and a power consumption may be largely reduced.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A transmission power control method of a mobile communication terminal, the method comprising:
reading a recent power value of a transmitter which successfully connected to a base station, from a nonvolatile memory;
decreasing a power value of the transmitter by a predetermined amount to be less than the recent power value until a connection to the base station fails, when the connection to the base station was successful with the recent power value; and
storing the power value of the transmitter which successfully connected to the base station immediately prior to the power value with which the connection to the base station fails, as the recent power value in the nonvolatile memory, according to the decreasing a power value of the transmitter.

2. The method of claim 1, further comprising:
increasing the power value of the transmitter by the predetermined amount to be greater than the recent power value until the connection to the base station succeeds, when the connection to the base station had failed with the recent power value; and
storing the power value of the transmitter which successfully connected to the base station as the recent power value in the nonvolatile memory, according to the increasing a power value of the transmitter.

3. The method of claim 1, wherein, in the decreasing a power value of the transmitter, the power value is decreased by an amount greater than the predetermined amount after a predetermined period of time passes.

4. The method of claim 1, wherein the mobile communication terminal connects to the base station by using any one among a half-duplex transceiver and a full-duplex transceiver.

5. A method of controlling a transmission power of a wireless transmitter when a mobile communication terminal connects to a base station by using a nonvolatile memory, the method comprising:
reading a recent power value of the wireless transmitter which successfully connected to the base station, from the nonvolatile memory;
increasing a power value of the wireless transmitter by a predetermined amount to be greater than the recent power value until a connection to the base station succeeds, when the connection to the base station had failed with the recent power value; and
storing the power value of the wireless transmitter which successfully connected to the base station as the recent power value in the nonvolatile memory according to the increasing a power value of the wireless transmitter.

6. A mobile communication terminal comprising:
a nonvolatile memory storing a recent power value of a transmitter which successfully connected to a base station; and
a control unit controlling the transmitter to transmit a signal to the base station according to the recent power value stored in the nonvolatile memory for a connection to the base station, and determining a success of the connection when a corresponding response is received from the base station, or determining a failure of the connection when the corresponding response is not received from the base station,
wherein the control unit decreases the power value of the transmitter by a predetermined amount to be less than the recent power value until the connection to the base station fails and stores the power value of the transmitter which successfully connected to the base station immediately prior to the power value with which the connection to the base station fails, as the recent power value in the nonvolatile memory, when the connection to the base station was successful with the recent power value.

7. The mobile communication terminal of claim 6, wherein the control unit increases the power value of the transmitter by the predetermined amount to be greater than the recent power value until the connection to the base station succeeds, and stores the power value of the transmitter which successfully connected to the base station as the recent power value in the nonvolatile memory, when the connection to the base station fails by the recent power value.

8. The mobile communication terminal of claim 6, wherein the control unit controls the power value of the transmitter to be decreased by the predetermined amount to be less than the recent power value for a predetermined period of time until the connection to the base station fails, and controls the power value to be decreased by a greater amount than the predetermined amount after the predetermined period of time passes.

9. The mobile communication terminal of claim 6, wherein any one among a half-duplex transceiver and a full-duplex transceiver is used for the connection to the base station.

10. A mobile communication terminal comprising:
a nonvolatile memory storing a recent power value which successfully connected to a base station;
a wireless transmitter transmitting a signal for a connection to the base station;
a wireless receiver receiving a signal from the base station responding to the signal which the wireless transmitter transmits; and
a control unit controlling the wireless transmitter to transmit the signal for the connection to the base station according to the recent power value stored in the nonvolatile memory for the connection to the base station, and determining a success of the connection when a corresponding response is received from the base station, or determining a failure of the connection when the corresponding response is not received from the base station,
wherein, the control unit increases the power value of the wireless transmitter by a predetermined amount to be greater than the recent power value until the connection to the base station succeeds, and stores the power value of the wireless transmitter which successfully connected to the base station as the recent power value in the nonvolatile memory, when the connection to the base station fails with the recent power value.
